(19) United States
(12) Patent Application Publication
(10) Pub. No.: US 2022/0080492 A1
(43) Pub. Date: Mar. 17, 2022

(54) PRESS APPARATUS

(71) Applicant: DAI-ICHI DENTSU LTD., Chofu-City, Tokyo (JP)

(72) Inventors: Takeshi EGUCHI, Chofu-City, Tokyo (JP); Takahiro INOUE, Chofu-City, Tokyo (JP); Masakazu MIYATA, Gifu-City, Gifu (JP)

(21) Appl. No.: 17/614,953

(22) PCT Filed: Jan. 17, 2020
(86) PCT No.: PCT/JP2020/001594

§ 371 Date: Nov. 29, 2021

(51) Int. Cl. B21J 15/26; B21J 15/10

(52) U.S. Cl. CPC B21J 15/26; B21J 15/10

(57) ABSTRACT

A compact press apparatus is provided that is capable of assuring the acceptability of a pressing, and in which the pressing location tends not to be restricted. Such a press apparatus includes a frame (1, 77) and a servopress (31, 50, 60, 101). A servomotor (33, 52, 62, 103) is provided within a first frame part (11, 17, 19, 79) or within a connecting-frame part (15, 83). At least a portion of a power-transmission mechanism (40, 56, 66, 90, 110) is provided within the first frame part (15, 83).

### TECHNICAL FIELD

The present invention relates to a press apparatus.

### BACKGROUND ART

Previously existing press apparatuses are disclosed in Patent Documents 1, 2. Each of these press apparatuses comprises a frame and a servopress, which is provided on the frame.

The frame comprises a first frame part, a second frame part, which faces the first frame part in a first direction, and a connecting-frame part, which connects the first frame part and the second frame part. The frame has a C shape or a U shape.

The servopress comprises a servomotor, a ram, a power-transmission mechanism, and a load-measuring means. The servomotor is operated by a controller and causes a rotary shaft to rotate. The ram is capable of reciprocating motion in a first direction between the first frame part and the second frame part, and a die or the like is fixed to the ram. The power-transmission mechanism converts the rotation of the rotary shaft into reciprocating motion of the ram. The load-measuring means is capable of measuring the load of the ram.

The press apparatus is provided on, for example, a robot arm and is capable of pressing, via the die or the like, rivets or the like at various locations. In particular, because the press apparatus can measure, using the load-measuring means, the load of the ram during pressing, the press apparatus is also capable of assuring the acceptability of the pressing.

### PRIOR ART LITERATURE

### Patent Documents

Patent Document 1

PCT International Publication No. WO 2019/013006

### Patent Document 2

PCT International Publication No. WO 2019/013007

### SUMMARY OF THE INVENTION

### Problem to be Solved by the Invention

However, with regard to the above-mentioned previously existing press apparatus, because the servomotor and the power-transmission mechanism are provided outside of the frame, the entirety of the servomotor and the power-transmission mechanism protrudes from the frame, thus increasing the size of the press apparatus. Consequently, in the situation in which the press apparatus is provided on, for example, a robot arm, limits to the movement of the robot arm tend to occur, and therefore the locations at which the rivet or the like is pressed tend to be restricted.

The present invention was conceived considering the above-mentioned existing circumstances, and the problem to be solved by the present invention is to provide a compact press apparatus that is capable of assuring the acceptability of pressing and in which the pressing location tends not to be restricted.

### Means for Solving the Problems

A press apparatus of the present invention is a press apparatus comprising: a frame that comprises a first frame part, a second frame part, which faces the first frame part in a first direction, and a connecting-frame part, which connects the first frame part and the second frame part; and a servopress, which is provided on the frame, comprising a servomotor, which causes a rotary shaft to rotate, a ram, which is capable of reciprocating motion in the first direction between the first frame part and the second frame part, a power-transmission mechanism that converts the rotation of the rotary shaft into reciprocating motion of the ram, and a load-measuring means that is capable of measuring the load on the ram, wherein:

the servomotor is provided within the first frame part or within the connecting-frame part; and

at least a portion of the power-transmission mechanism is provided within the first frame part.

With regard to the press apparatus of the present invention, because the servomotor is provided within the first frame part or within the connecting-frame part and because at least a portion of the power-transmission mechanism is provided within the first frame part, the portion that protrudes from the frame can be made small or eliminated. In addition, in this press apparatus as well, the load on the ram during pressing can be measured.

Accordingly, the press apparatus of the present invention can assure the acceptability of the pressing, is compact, and tends not to be limited with respect to the pressing location.

The power-transmission mechanism may comprise a nut extending in the first direction, a screw shaft extending in the first direction within the nut, and a plurality of balls disposed between the nut and the screw shaft. In addition, one of the nut and the screw shaft may be rotationally driven by the rotary shaft. Furthermore, the other of the nut and the screw shaft may be formed integrally with the ram in the state in which, while transmitting a load, it is non-rotatable relative to the frame owing to a linear-motion mechanism having a rotation-stopping function. In this situation, a ball-screw mechanism, which is widely used in servopresses, can constitute the power-transmission mechanism, and thereby simplification of the structure can be achieved.

In the situation in which the ball-screw mechanism constitutes the power-transmission mechanism, preferably the nut is rotationally driven by the rotary shaft. In addition, the linear-motion mechanism is preferably a linear-motion guide that comprises a guide part provided on the frame and extending in the first direction and a guided part provided on the screw shaft or the ram and guided by the guide part. In this situation, the overall length of the ball-screw mechanism of the power-transmission mechanism can be shortened more than in the situation in which the screw shaft is rotationally driven by the rotary shaft. In addition, because the screw shaft is integral with the ram and because the linear-motion mechanism can be constituted by a simple linear-motion guide, simplification of the structure can be better achieved.

The power-transmission mechanism may comprise a nut extending in the first direction, a screw shaft extending in the first direction within the nut, and a plurality of planetary-roller screws disposed between the nut and the screw shaft. In addition, one of the nut and the screw shaft may be rotationally driven by the rotary shaft. Furthermore, the other of the nut and the screw shaft may be formed integrally with the ram in the state in which, while transmitting a load, it is non-rotatable relative to the frame owing to a linear-motion mechanism having a rotation-stopping function. In this situation, because the planetary-roller screw mechanism constitutes the power-transmission mechanism, which can transmit a large load, the load that can be applied by the press apparatus can be made large. In addition, because the pitch of the planetary-roller screw mechanism is fine, a speed-reducing mechanism can be made unnecessary, and thereby a more compact press apparatus can be achieved.

In the situation in which the planetary-roller screw mechanism constitutes the power-transmission mechanism, the screw shaft is preferably rotationally driven by the rotary shaft. In addition, the linear-motion mechanism is preferably a ball spline comprising a first ball groove provided on the first frame part and extending in the first direction, a second ball groove provided on the nut and extending in the first direction, and a plurality of balls provided between the first ball groove and the second ball groove. In this situation, because the nut is integral with the ram and because the linear-motion mechanism is constituted by a ball spline, whose volume is smaller than that of the linear-motion guide, it can be made more compact.

The servomotor may comprise a rotor, which rotates integrally with the rotary shaft, and a stator. The connecting-frame part or the first frame part preferably fixes the stator. In this situation, because the connecting-frame part or the first fame part also serves as a motor housing, a motor housing becomes unnecessary, and therefore a reduction in manufacturing cost can be achieved owing to a reduction in the part count.

The press apparatus of the present invention may have one servopress or may have two or more servopresses. In the situation in which there is one servopress, the servomotor is provided within the first frame part or within the connecting-frame part of the frame. That is, the portion of the frame in which the servomotor is not provided is the second frame part. In the situation in which there are two servopresses, the press apparatus of the present invention can comprise a second servopress, which is provided on the frame. The second servopress may comprise a second servomotor, which causes a second rotary shaft to rotate, a second ram, which is capable of reciprocating motion in the first direction between the first frame part and the second frame part, a second power-transmission mechanism, which converts the rotation of the second rotary shaft to reciprocating motion of the second ram, and a second load-measuring means, which is capable of measuring the load of the second ram. Furthermore, the ram and the second ram preferably face one another. In this situation, it is possible to press a workpiece from both sides using the ram and the second ram.

### Effects of the Invention

The press apparatus of the present invention is capable of assuring the acceptability of the pressing, is more compact than those in the past, and tends not to be limited with respect to the pressing location. Consequently, in the situation in which the press apparatus is provided on, for example, a robot arm, limitations on the movement of the robot arm tend not to occur, and pressure can be applied to rivets or the like at various locations.

### BRIEF DESCRIPTION OF THE DRAWINGS

FIG. 1 is a cross-sectional view of the state in which a ram has been raised, according to a press apparatus of Working Example 1.

FIG. 2 is a cross-sectional view of the state in which the ram has been lowered, according to the press apparatus of Working Example 1.

FIG. 3 is a cross-sectional view of a press apparatus of Working Example 2.

FIG. 4 is a cross-sectional view of the state in which the ram has been raised, according to a press apparatus of Working Example 3.

FIG. 5 is a cross-sectional view of the state in which the ram has been lowered, according to the press apparatus of Working Example 3.

### MODES FOR CARRYING OUT THE INVENTION

Working Examples 1-3, which embody the present invention, will be explained below, with reference to the drawings.

### WORKING EXAMPLE 1

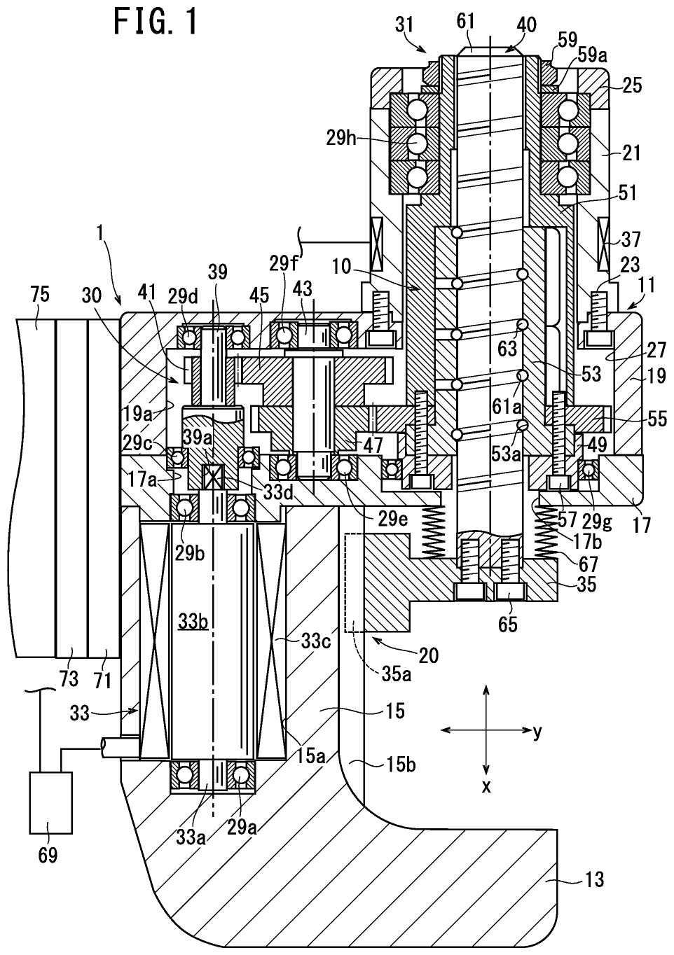

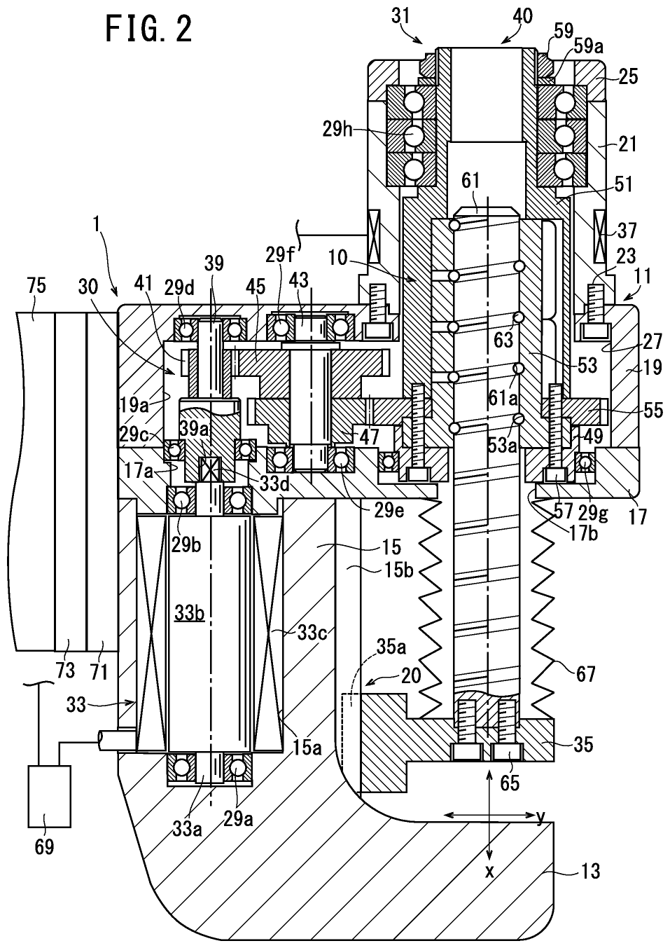

As shown in FIG. 1 and FIG. 2, a press apparatus of Working Example 1 comprises a frame 1 and a servopress 31, which is provided on the frame 1.

The frame 1 comprises a first frame part 11, a second frame part 13, which faces the first frame part 11 in a first direction x, and a connecting-frame part 15, which connects the first frame part 11 and the second frame part 13. The first frame part 11 and the second frame part 13 extend in a second direction y, which is orthogonal to the first direction x. The frame 1 has a C shape or a U shape. Hereinbelow, the first frame part 11 side of the frame 1 is the upper side, and the second frame part 13 of the frame 1 is the lower side.

The second frame part 13 and the connecting-frame part 15 are integrally cast in an L shape. A motor chamber 15a, which is hollowed out in the connecting-frame part 15 in a circular-column shape extending in the first direction x, is recessed from its upper surface. A first main body 17, which extends in the second direction y, is fastened to the connecting-frame part 15, and a second main body 19, which extends in the second direction y, is fastened to the first main body 17. The connecting-frame part 15, the first main body 17, and the second main body 19 are fastened by a plurality of not-shown bolts. The first main body 17 and the second main body 19 constitute the first frame part 11.

A bearing housing 21, which extends in a circular-cylinder shape in the first direction x, is fastened, by a plurality of bolts 23, to the second main body 19. In addition, a bearing cover 25, which has a ring shape, is joined to the bearing housing 21.

A first shaft hole 17a, which is coaxial with the motor chamber 15a and extends in the first direction x, penetrates through the first main body 17, and a second shaft hole 17b, which is parallel to the first shaft hole 17a, penetrates through the first main body 17. A gear chamber 19a is formed within the second main body 19. A nut chamber 27, which communicates with the gear chamber 19a, is formed within the first main body 17, the second main body 19, the bearing housing 21, and the bearing cover 25.

A first bearing 29a is provided in the connecting-frame part 15 on the lower side of the motor chamber 15a, and a second bearing 29b, which is coaxial with the first bearing 29a, is provided on the motor chamber 15a side of the first shaft hole 17a. In addition, a third bearing 29c, which is coaxial with the first and second bearings 29a, 29b, is provided in the connecting-frame part 15 on the gear chamber 19a side of the first shaft hole 17a, and a fourth bearing 29d, which is coaxial with the first to third bearings 29c, is provided in the second main body 19.

In addition, a fifth bearing 29e is provided in the connecting-frame part 15 such that it is adjacent to the third bearing 29c, and a sixth bearing 29f, which is coaxial with the fifth bearing 29e, is provided in the second main body 19 such that it is adjacent to the fourth bearing 29d. Furthermore, a seventh bearing 29g is provided in the connecting-frame part 15 such that it is adjacent to the fifth bearing 29e, and an eighth bearing 29h, which is coaxial with the seventh bearing 29g, is provided in the bearing housing 21 and the bearing cover 25 such that it is adjacent to the sixth bearing 29f.

The servopress 31 comprises a servomotor 33, a ram 35, a power-transmission mechanism 40, and a load cell 37. The servomotor 33 comprises a rotary shaft 33a, a rotor 33b, and a stator 33c, which is disposed around the rotor 33b. The rotor 33b rotates integrally with the rotary shaft 33a. The rotary shaft 33a is axially supported by the first bearing 29a and the second bearing 29b. The stator 33c is fixed to an inner circumference of the motor chamber 15a.

A square-column part 33d is formed on the rotary shaft 33a, which protrudes into the interior of the first shaft hole 17a. A first shaft 39 is axially supported by the third bearing 29c and the fourth bearing 29d, and the square-column part 33d of the rotary shaft 33a engages with an engaging hole 39a of the first shaft 39. A first gear 41 is fixed to the first shaft 39.

A second shaft 43 is axially supported by the fifth bearing 29e and the sixth bearing 29f. A second gear 45 and a third gear 47 are fixed to the second shaft 43. The diameter of the second gear 45 is larger than that of the first gear 41, and also has a higher tooth count. The diameter of the third gear 47 is smaller than that of the second gear 45 and also has a lower tooth count. The second gear 45 meshes with the first gear 41, and the third gear 47 is located on the fifth bearing 29e side of the second gear 45.

A turntable 49, which has a circular-cylinder shape, is axially supported by the seventh bearing 29g, and a nut holder 51, which has a circular-cylinder shape, is axially supported by the eighth bearing 29h. Between the turntable 49 and the nut holder 51, a nut 53 and a fourth gear 55 are fixed by a plurality of bolts 57. The turntable 49, the nut 53, the fourth gear 55, and the nut holder 51 are axially supported by the seventh bearing 29g and the eighth bearing 29h. A female thread is formed on the upper end of the nut holder 51; the eighth bearing 29h is sandwiched and held by a nut 59—with a washer 59a interposed therebetween—which screws together with the female thread of the nut holder 51, and the nut holder 51. The diameter of the fourth gear 55 is larger than that of the third gear 47 and also has a higher tooth count. The fourth gear 55 meshes with the third gear 47.

A screw shaft 61, which extends in the first direction x, is provided within the nut 53 and the nut holder 51. The load cell 37 is fixed to the bearing housing 21. One thread groove 53a is recessed in the inner-circumferential surface of the nut 53, one thread groove 61a is recessed also in the outer-circumferential surface of the screw shaft 61, and a plurality of balls 63 is provided in a movable manner between the thread groove 53a and the thread groove 61a. A circulation passageway, along which the balls 63 circulate, is formed in the nut 53 between the thread groove 53a and the thread groove 61a.

The ram 35 is fixed, by a plurality of bolts 65, to the lower end of the screw shaft 61. A guide part 15b, which extends in the first direction x, is formed on the connecting-frame part 15, and a guided part 35a, which is guided by the guide part 15b, is formed on the ram 35. The guide part 15b has a rail shape, and the guided part 35a is configured such that it sandwiches the guide part 15b on the near side and the far side of the paper plane. A bellows 67, which is made of rubber, is provided between the first main body 17 and the ram 35. It is configured such that a die or the like may be fixed to the ram 35.

The nut 53, the screw shaft 61, and the plurality of balls 63 constitute a ball-screw mechanism 10. The guide part 15b and the guided part 35a constitute a linear-motion guide 20, which, while transmitting a load, has a rotation-stopping function. The first to eighth bearings 29a-29h, the first shaft 39, the first gear 41, the second shaft 43, the second gear 45, the third gear 47, and the fourth gear 55 constitute a speed-reducing mechanism 30. The ball-screw mechanism 10, the linear-motion guide 20, and the speed-reducing mechanism 30 constitute the power-transmission mechanism 40.

A controller 69 is connected to the stator 33c of the servomotor 33 and to the load cell 37. The servomotor 33 is operated by the controller 69 and causes the rotary shaft 33a to rotate. The load cell 37 serves as a load-measuring means and detects the load that acts on the screw shaft 61 via the ram 35, the screw shaft 61, the nut 53, the nut holder 51, the bearing 29h, the bearing cover 25, and the bearing housing 21. The controller 69 is connected to a computer, which is not shown. The connecting-frame part 15, the first main body 17, and the second main body 19 are configured such that they are fixed to a robot arm 75 by using plates 71, 73.

In the situation in which a pressing process is performed by the press apparatus, the robot arm 75 causes the press apparatus to move to various locations, and the controller 69 causes the servomotor 33 to operate. First, as shown in FIG. 1, the servomotor 33 drives the rotor 33b and thereby the rotary shaft 33a rotates. The rotation of the rotary shaft 33a is transmitted, via the first shaft 39 and the second shaft 43, to the turntable 49, the nut 53, the fourth gear 55, and the nut holder 51. During this interval, the rotational speed of the rotary shaft 33a is reduced. Owing to the rotation of the nut 53, as shown in FIG. 2, the screw shaft 61 travels from the first frame part 11 toward the second frame part 13, extending in the first direction x.

Consequently, the ram 35 is guided by the linear-motion guide 20 and descends in the first direction x toward the second frame part 13 in the state in which it is non-rotatable relative to the frame 1. Consequently, it is possible to press, via the die or the like, rivets or the like at various locations. In particular, with regard to this press apparatus, the load cell 37 measures the load that acts on the screw shaft 61 during pressing, and the computer determines acceptability during the pressing based on each load and the movement distance of the ram 35, and records each pressing force. If the servomotor 33 rotates the rotary shaft 33a in the reverse direction, then the ram 35 ascends in the first direction x such that it moves away from the second frame part 13.

During this interval, with regard to the press apparatus, because the servomotor 33 is provided within the connecting-frame part 15 and because the speed-reducing mechanism 30 of the power-transmission mechanism 40 is provided within the first frame part 11, only a portion of the ball-screw mechanism 10 protrudes from the frame 1. The linear-motion guide 20 is irrelevant to a size increase of the frame 1. In particular, with regard to this press apparatus, the ball-screw mechanism 10, which is widely used in well-known servopresses, constitutes the power-transmission mechanism 40. In addition, because the nut 53 is rotationally driven by the rotary shaft 33a, the overall length of the ball-screw mechanism 10 of the power-transmission mechanism 40 can be shortened more than the situation in which the screw shaft 61 is rotationally driven by the rotary shaft 33a. In addition, the screw shaft 61 is integral with the ram 35, and a linear-motion mechanism is constituted by the linear-motion guide 20, which is simple. Consequently, simplification of the structure is achieved. In addition, in this press apparatus as well, the load of the ram 35 during pressing can be measured through the load that acts on the screw shaft 61.

Accordingly, the press apparatus is capable of assuring the acceptability of the pressing, is more compact than those in the past, and tends not to be limited with respect to the pressing location. Consequently, even though the press apparatus is provided on the robot arm 75, limitations on the movement of the robot arm 75 tend not to occur, and pressure can be applied to rivets or the like at various locations.

In addition, with regard to this press apparatus, because the connecting-frame part 15 fixes the stator 33c and because the connecting-frame part 15 also serves as a motor housing, a motor housing becomes unnecessary, and therefore a reduction in manufacturing cost can be achieved owing to a reduction in the part count.

### WORKING EXAMPLE 2

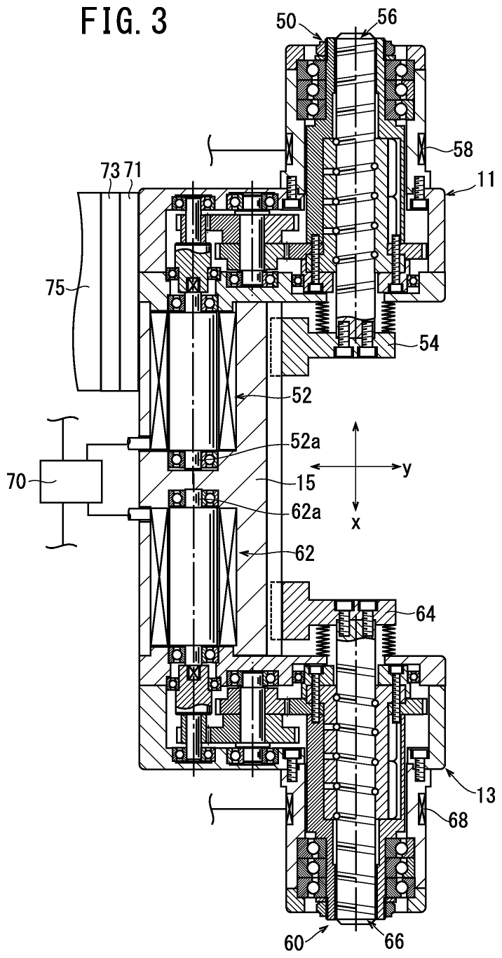

As shown in FIG. 3, a press apparatus of Working Example 2 comprises first and second servopresses 50, 60. The first servopress 50 is the same as the servopress 31 of Working Example 1; the second servopress 60 is the servopress 31 of Working Example 1 vertically inverted and is provided on the second frame part 13.

The first servopress 50 comprises: a second servomotor 52, which causes a first rotary shaft 52a to rotate; a first ram 54, which is capable of reciprocating motion in the first direction x between the first frame part 11 and the second frame part 13; a first power-transmission mechanism 56, which converts the rotation of the first rotary shaft 52a into reciprocating motion of the first ram 54; and a first load cell 58, which is capable of measuring the load of the first ram 54.

The second servopress 60 comprises: a second servomotor 62, which causes a second rotary shaft 62a to rotate; a second ram 64, which is capable of reciprocating motion in the first direction x between the first frame part 11 and the second frame part 13; a second power-transmission mechanism 66, which converts the rotation of the second rotary shaft 62a into reciprocating motion of the second ram 64; and a second load cell 68, which is capable of measuring the load of the second ram 64.

A controller 70 is connected to the stator of the first servomotor 52 and to the first load cell 58 and is connected to the stator of the second servomotor 62 and to the second load cell 68. The first and second servomotors 52, 62 are operated by the controller 70 and cause the first and second rotary shafts 52a, 62a to rotate synchronously. At this time, the first and second servomotors 52, 62 may be operated synchronously and may be operated such that, in accordance with the workpiece, after one of the first and second servomotors 52, 62 operates and makes contact with the workpiece, the other of the first and second servomotors 52, 62 begins to operate. The first load cell 58 detects the load that acts on the screw shaft via the first ram 54, and the second load cell 68 detects the load that acts on the screw shaft via the second ram 64. The connecting-frame part 15 and the first frame part 11 are configured such that they are fixed to the robot arm 75 by using the plates 71, 73. The first ram 54 and the second ram 64 face one another.

With regard to the press apparatus of Working Example 2, it is possible to press the workpiece from both sides using the first ram 54 and the second ram 64. Other functions and effects are the same as those in Working Example 1.

### WORKING EXAMPLE 3

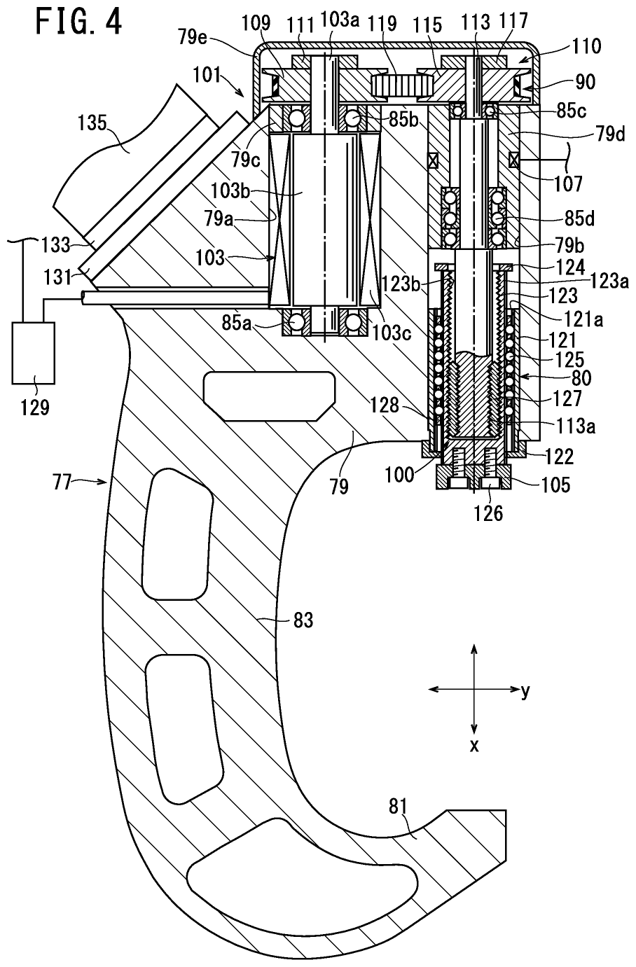

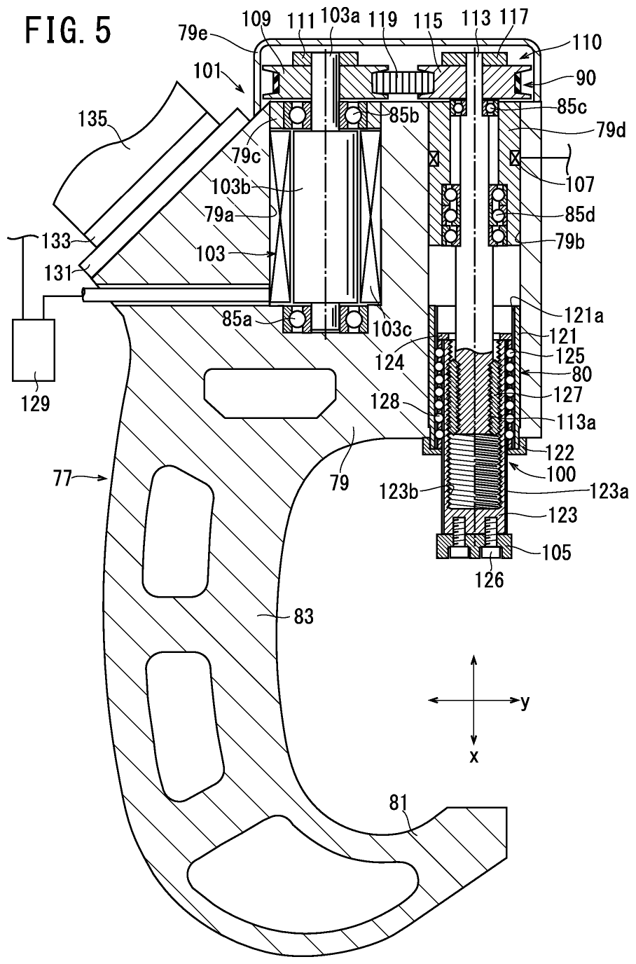

As shown in FIG. 4 and FIG. 5, a press apparatus of Working Example 3 comprises a frame 77 and a servopress 101, which is provided on the frame 77.

The frame 77 comprises a first frame part 79, a second frame part 81, which faces the first frame part 79 in the first direction x, and a connecting-frame part 83, which connects the first frame part 79 and the second frame part 81. The first frame part 79 and the second frame part 81 extend in the second direction y, which is orthogonal to the first direction x. Hereinbelow, the first frame part 79 side of the frame 77 is referred to as the upper side, and the second frame part 81 of the frame 77 is referred to as the lower side.

The first frame part 79, the second frame part 81, and the connecting-frame part 83 are cast integrally in a C shape or a U shape. A motor chamber 79a, which is hollowed out in a circular-column shape extending in the first direction x, and a nut chamber 79b, which is hollowed out in a circular-column shape extending parallel to the motor chamber 79a, are recessed in the first frame part 79 from its upper surface.

A first bearing 85a is provided in the first frame part 79 on the lower side of the motor chamber 79a, a first spacer 79c is fixed to the upper side of the motor chamber 79a, and a second bearing 85b, which is coaxial with the first bearing 85a, is provided in the first spacer 79c. In addition, a second spacer 79d is fixed to the first frame part 79 on the upper side of the nut chamber 79b, and a third bearing 85c and a fourth bearing 85d, which is coaxial with the third bearing 85c, are provided in the second spacer 79d. The first spacer 79c and the second spacer 79d are a portion of the first frame part 79.

The servopress 101 comprises a servomotor 103, a ram 105, a power-transmission mechanism 110, and a load cell 107. The servomotor 103 comprises a rotary shaft 103a, a rotor 103b, and a stator 103c, which is disposed around the rotor 103b. The rotor 103b rotates integrally with the rotary shaft 103a. The rotary shaft 103a is axially supported by the first bearing 85a and the second bearing 85b. The stator 103c is fixed to the inner circumference of the motor chamber 79a.

A first pulley 109 is fixed to the rotary shaft 103a, which protrudes upward from the motor chamber 79a, and the first pulley 109 is retained by a fastener 111, which engages with the rotary shaft 103a. Within the second spacer 79d, a screw shaft 113 is axially supported by the third bearing 85c and the fourth bearing 85d. A second pulley 115 is fixed to the screw shaft 113, which protrudes upward from the nut chamber 79b, and the second pulley 115 is retained by a fastener 117, which engages with the screw shaft 113. A timing belt 119 is looped around the first pulley 109 and the second pulley 115. A cover 79e, which covers the first pulley 109, the second pulley 115, the timing belt 119, etc., is fixed to the upper end of the first frame part 79. The cover 79e is a portion of the first frame part 79.

A third spacer 121 is fixed in the lower side of the nut chamber 79b. The third spacer 121 is also a portion of the first frame part 79. First ball grooves 121a, which extend in the first direction x, are recessed in the inner-circumferential surface of the third spacer 121.

A nut 123 is disposed within the third spacer 121. The nut 123 has a bottomed, circular-cylinder shape. It is also possible to use a nut having a circular-cylinder shape. Second ball grooves 123a, which extend in the first direction x, are recessed in the outer-circumferential surface of the nut 123. A plurality of balls 125 is provided between the first ball groove 121a and the second ball groove 123a. The balls 125 are held by a ball cage 128. The first ball grooves 121a, the balls 125, and the second ball grooves 123a constitute a ball spline 80, which, while transmitting a load, has a rotation-stopping function.

A stopper 124, which has a ring shape, is fixed to an upper surface of the nut 123. The outer diameter of the stopper 124 is larger than the diameter of the second ball grooves 123a and is smaller than the diameter of the first ball grooves 121a. Consequently, the nut 123 is movable within the third spacer 121 until the stopper 124 makes contact with the ball cage 128.

A ball holder 122, which has a ring shape and makes contact with the lower end of the third spacer 121, is fixed to a lower surface of the first frame part 79. The inner diameter of the ball holder 122 is larger than the diameter of the second ball grooves 123a and is smaller than the diameter of the first ball grooves 121a. Consequently, the ball cage 128 is configured such that, owing to the ball holder 122, it will not drop.

A female thread 123b is formed in the inner-circumferential surface of the nut 123. The screw shaft 113 extends into the nut 123. A male thread 113a is formed on the outer-circumferential surface of a lower portion of the screw shaft 113. A plurality of planetary-roller screws 127 is provided between the nut 123 and the screw shaft 113. Each of the planetary-roller screws 127 screws together with the female thread 123b of the nut 123 and the male thread 113a of the screw shaft 113. Each of the planetary-roller screws 127 is configured such that, owing to a not-shown holder, angles with respect to each other around the screw shaft 113 are maintained. The ram 105 is fixed, by a plurality of bolts 126, to the lower end of the nut 123.

The first to fourth bearings 85a-85d, the first pulley 109, the second pulley 115, and the timing belt 119 constitute a constant-velocity mechanism 90. The nut 123, the screw shaft 113, and the planetary-roller screws 127 constitute a planetary-roller screw mechanism 100. The planetary-roller screw mechanism 100, the ball spline 80, and the constant-velocity mechanism 90 constitute the power-transmission mechanism 110.

A controller 129 is connected to the stator 103c of the servomotor 103 and to the load cell 107. The servomotor 103 is operated by the controller 129 and causes the rotary shaft 103a to rotate. The first frame part 79 is configured such that it is fixed to a robot arm 135 by using plates 131, 132. Other structural elements are the same as those in the press apparatus according to Working Example 1.

In the situation in which the pressing process is performed by this press apparatus, too, the robot arm 135 causes the press apparatus to move to various locations, and the controller 129 causes the servomotor 103 to operate. First, as shown in FIG. 4, the servomotor 103 drives the rotor 103b, and thereby the rotary shaft 103a rotates. The rotation of the rotary shaft 103a is transmitted to the screw shaft 113 via the first pulley 109, the timing belt 119, and the second pulley 115. Owing to the rotation of the screw shaft 113, as shown in FIG. 5, the nut 123 travels from the first frame part 79 toward the second frame part 81, extending in the first direction x.

Consequently, the ram 105 is guided by the ball spline 80 and, in the state in which it is non-rotatable relative to the frame 77, descends in the first direction x toward the second frame part 81. Consequently, it is possible to press, using a die or the like, rivets or the like at various locations. If the servomotor 103 rotates the rotary shaft 103a in the reverse direction, then the ram 105 ascends in the first direction x such that it moves away from the second frame part 81.

During this interval, with regard to this press apparatus, because the servomotor 103 is provided within the first frame part 79 and the power-transmission mechanism 110 is provided within the first frame part 79, the power-transmission mechanism 110 does not protrude from the frame 77. In addition, the ball spline 80, which has a small volume, constitutes a linear-motion mechanism. In particular, with regard to this press apparatus, the planetary-roller screw mechanism 100 can transmit a large load, and thereby the load that can be applied can be made large. In addition, because the pitch of the planetary-roller screw mechanism 100 is fine, a speed-reducing mechanism becomes unnecessary, and thereby a more compact press apparatus can be achieved.

Accordingly, this press apparatus is capable of assuring the acceptability of the pressing, is compact, tends not to be limited with respect to the pressing location, and moreover can perform a higher quality pressing process. Other functions and effects are the same as those in Working Example 1.

The present invention was explained above based on Working Examples 1-3, but the present invention is not limited to Working Examples 1-3 and it goes without saying the present invention can be modified as appropriate within a range that does not depart from the gist thereof.

For example, in Working Examples 1-3, the load cells 37, 58, 68, 107 are used as the load-measuring means; however, it is also possible to use other sensors such as dynamic sensors or force sensors or to measure the load on the rotary shafts 33a, 52a, 62a, 103a using an electric-current value, which can be measured at the servomotors 33, 52, 62, 103.

In Working Example 2, two of the servopresses 31 of Working Example 1 are used, but it is also possible to use two of the servopresses 101 of Working Example 3.

The power-transmission mechanism is not limited to the ball-screw mechanism 10 or to the planetary-roller screw mechanism 100, and it is also possible to use other mechanisms. In addition, the speed-reducing mechanism and the constant-velocity mechanism are not limited to mechanisms that use gears or a belt as in Working Examples 1-3, and it is also possible to use other mechanisms in which a chain or the like is used.

In Working Examples 1, 2, the guide part 15b may be provided indirectly on the frame 1, and the guided part 35a also may be provided indirectly on the screw shaft 61 or the ram 35. In addition, in Working Example 3, the first ball grooves 121a may be provided directly on the first frame part 79, and the second ball grooves 123a also may be provided indirectly on the nut 123. It is also possible to use mechanisms other than the linear-motion guide 20 or the ball spline 80 as the linear-motion mechanism.

In Working Examples 1, 2, the second frame part 13 and the connecting-frame part 15 are cast integrally, but it is also possible to make these separate and integrate them using bolts or the like. In addition, the second frame part 13, the connecting-frame part 15, the first main body 17, and the second main body 19 are not limited to being separate bodies and may be integrated as long as their structures are established.

A ball-screw mechanism may constitute the power-transmission mechanism and a screw shaft may be rotationally driven by a rotary shaft, or a planetary-roller screw mechanism may constitute the power-transmission mechanism and a nut may be rotationally driven by a rotary shaft.

The servomotor is not limited to being the inner-rotor type used in Working Examples 1-3 and may be an outer-rotor type.

### INDUSTRIAL FIELD OF APPLICATION

The present invention can be used in a riveting apparatus, plastic working, and the like.

### EXPLANATION OF THE REFERENCE NUMBERS

11, 17, 19, 79 First frame parts (17: first main body, 19: second main body)
x First direction
13, 81 Second frame parts
15, 83 Connecting-frame parts
1, 77 Frames
33a, 52a, 62a, 103a Rotary shafts
33, 52, 62, 103 Servomotors
35, 54, 64, 105 Rams
40, 56, 66, 90, 110 Power-transmission mechanisms (10: ball-screw mechanism, 30: speed-reducing mechanism, 90: constant-velocity mechanism, 100: planetary-roller screw mechanism)
37, 58, 68, 107 Load-measuring means (load cells)
31, 50, 60, 101 Servopresses
53, 123 Nuts
61, 113 Screw shafts
63, 125 Balls
20, 80 Linear-motion mechanisms (20: linear-motion guide, 80: ball spline)
15b Guide part
35a Guided part
127 Planetary-roller screw
121a First ball groove
123a Second ball groove
33b, 103b Rotors
33c, 103c Stators

1. A press apparatus comprising:
a frame that comprises a first frame part, a second frame part, which faces the first frame part in a first direction, and a connecting-frame part, which connects the first frame part and the second frame part; and
a servopress, which is provided on the frame, comprising a servomotor, which causes a rotary shaft to rotate, a ram, which is capable of reciprocating motion in the first direction between the first frame part and the second frame part, a power-transmission mechanism that converts the rotation of the rotary shaft into reciprocating motion of the ram, and a load-measuring means that is capable of measuring a load on the ram;
wherein:
the frame is fixed to a robot arm;
the servomotor is accommodated in a motor chamber defined within the first frame part or within the connecting-frame part; and
at least a portion of the power-transmission mechanism is provided within the first frame part.

2. The press apparatus according to claim 1, wherein:
the power-transmission mechanism comprises:
a ball-screw mechanism that comprises a nut extending in the first direction, a screw shaft extending in the first direction within the nut, and a plurality of balls disposed between the nut and the screw shaft; and
a linear-motion mechanism configured to block rotation while a load is being transmitted;
the ball-screw mechanism is provided within the first frame part;
one of the nut and the screw shaft is rotationally driven by the rotary shaft; and
the other of the nut and the screw shaft is formed integrally with the ram in the state in which it is non-rotatable relative to the frame owing to the linear-motion mechanism.

3. The press apparatus according to claim 2, wherein:
the nut is rotationally driven by the rotary shaft; and
the linear-motion mechanism is a linear-motion guide that comprises a guide part provided on the frame and extending in the first direction and a guided part provided on the screw shaft or the ram and guided by the guide part.

4. The press apparatus according to claim 1, wherein:
the power-transmission mechanism comprises:
a planetary-roller screw mechanism that comprises: a nut extending in the first direction, a screw shaft extending in the first direction within the nut, and a plurality of planetary-roller screws disposed between the nut and the screw shaft; and
a linear-motion mechanism configured to block rotation while a load is being transmitted;
the planetary-roller screw mechanism is provided within the first frame part;
one of the nut and the screw shaft is rotationally driven by the rotary shaft; and
the other of the nut and the screw shaft is formed integrally with the ram in the state in which it is non-rotatable relative to the frame owing to the linear-motion mechanism.

5. The press apparatus according to claim 4, wherein:
the screw shaft is rotationally driven by the rotary shaft;
the linear-motion mechanism is a ball spline comprising a first ball groove provided on the first frame part and extending in the first direction, a second ball groove provided on the nut and extending in the first direction, and a plurality of balls provided between the first ball groove and the second ball groove; and
the linear-motion mechanism is provided within the first frame part.

6. The press apparatus according to claim 1, wherein:
the servomotor comprises a rotor, which rotates integrally with the rotary shaft, and a stator; and
the stator is fixed in the connecting-frame part or the first frame part.

7. The press apparatus according to claim 1, further comprising:
a second servopress, which is provided on the frame, comprising a second servomotor, which causes a second rotary shaft to rotate, a second ram, which is capable of reciprocating motion in the first direction between the first frame part and the second frame part, a second power-transmission mechanism, which converts the rotation of the second rotary shaft into reciprocating motion of the second ram, and a second load-measuring means, which is capable of measuring a load on the second ram;
wherein the ram and the second ram face one another.

8. The press apparatus according to claim 2, wherein:
the power-transmission mechanism comprises a speed-reducing mechanism that transmits rotation of the rotary shaft to the ball-screw mechanism; and
the speed-reducing mechanism is disposed within the first frame part.

9. The press apparatus according to claim 8, wherein:
the nut is rotationally driven by the rotary shaft; and
the linear-motion mechanism is a linear-motion guide that comprises a guide part provided on the frame and extending in the first direction and a guided part provided on the screw shaft or the ram and guided by the guide part.

10. The press apparatus according to claim 4, wherein:
the power-transmission mechanism comprises a constant-velocity mechanism that transmits rotation of the rotary shaft to the planetary-roller screw mechanism; and
the constant-velocity mechanism is disposed within the first frame part.

11. The press apparatus according to claim 10, wherein:
the screw shaft is rotationally driven by the rotary shaft;
the linear-motion mechanism is a ball spline comprising a first ball groove provided on the first frame part and extending in the first direction, a second ball groove provided on the nut and extending in the first direction, and a plurality of balls provided between the first ball groove and the second ball groove; and
the linear-motion mechanism is provided within the first frame part.
